(19) United States
(12) Patent Application Publication
(10) Pub. No.: US 2008/0229246 A1
(43) Pub. Date: Sep. 18, 2008

(54) DIGITAL SYSTEM FOR PLASTIC AND COSMETIC SURGERY

(76) Inventors: John R. Squilla, Rochester, NY (US); Daniel P. Schaertel, Webster, NY (US); Steven T. Russell, Spencerport, NY (US); Ralph P. Pennino, Victor, NY (US); Richard A. Simon, Rochester, NY (US)

Correspondence Address: Carestream Health, Inc.;Patent Legal Staff, 150 Verona Street, Rochester, NY, 14608, US

(21) Appl. No.: 11/687,127

(22) Filed: Mar. 16, 2007

(51) Int. Cl. G06F 3/048

(52) U.S. Cl. 715/835

(57) ABSTRACT

A system for plastic surgery comprises entering patient information (130) into a database; computing a template (160) for the patient based on the information; and inserting a synthetic model into the template.

### CROSS REFERENCE TO RELATED APPLICATIONS

Reference is made to commonly-assigned copending U.S. patent application Ser. No. 11/555,313, filed Nov. 1, 2006, entitled AUTOMATED CUSTOM REPORT GENERATION SYSTEM FOR MEDICAL INFORMATION, by Squilla et al., the disclosure of which is incorporated herein.

### FIELD OF THE INVENTION

The field of this invention is the area of medical systems, specifically plastic surgeons, dermatologists, and other physicians performing cosmetic procedures or other specialties that use photographic images as an integral part of their practices.

### BACKGROUND OF THE INVENTION

As a matter of routine, plastic surgeons, dermatologists, and other physicians performing cosmetic procedures, take photographs of their patients for patient photographic documentation. This documentation includes: before and after photos, to show results, to share with colleagues, and to prepare for the surgeries they are going to undertake. Plastic surgery residents often photograph most of their patients for educational purposes.

A guide on what photos should be considered and how to take them is published jointly by the American Society of Plastic Surgeons and The Plastic Surgery Educational Foundation and is entitled “Photographic Standards in Plastic Surgery.” It is a series of 12 “templates” for different parts of the body and not only suggests what photos to take, but how they should be taken in terms of distance and framing. This guide has a single model (female) and a suggested number of photos to be taken and the poses for each photo. As one can imagine, at times, a different pose or other photos can be desired.

Even using digital photography, the method of matching the digital photos to the template is tedious and time consuming. Often, application packages for digital editing (like PhotoShop from Adobe) are used to try and match the photos taken to the suggested photos in the guide. In addition, the standard problems of digital photography present themselves as well. These include downloading of the images, getting consistent color (especially from different cameras or different conditions and photos taken at different times (for the before and after photos or subsequent surgeries, for example). Additionally, measurements on the photograph may need to be taken. Storing the images (often in multiple locations and with specific image formats like DICOM) need to be supported as well as collaboration with other clinicians of sharing of information is left to the user as a task that is handled outside of the image manipulations.

Clinicians collect information about the patient as a matter of routine. This information is rarely attached to the images and not often utilized for actions utilizing the images. The workflow that is utilized by the clinicians, both the surgeon and their staff, can be greatly improved by optimizing the process of taking, manipulating, storing and sharing the images in a single application. In this application, clinician is defined as anyone on staff utilizing the present invention. Some templates shown do not have facial images in them as part of the template. By providing a simple means to add this to their process, one can easily see how errors can be reduced.

Prior art in this area includes both analog (non-digital) examples and those that have utilized aspects of digital photography. An example of the color discrepancies that can occur is shown in the Niamtu Imaging Systems website (see below) or in cosmetic surgery texts such as “Surgical Rejuvenation of the Face” by Thomas J Baker, MD and Howard L Gordon, MD (C. V. Cosby Co., 1986) and “Cosmetic Dermatolologic Surgery” Leonard M. Dzubow, MD (Lippencott/Raven, 1998). Software from digital cameras, like Kodak's EasyShare software, allows for images to be downloaded from the cameras relatively simply and store them logically, for example, by date. Kodak's EasyShare Gallery allows images to be uploaded and shared with others, although downloading of full resolution images by others is not allowed.

Templates are used in many software applications, including Professional Photographers and PictueIt from Microsoft. These applications allow for the sizing of images to suit the individual. Automated sizing of multiple photos on a page and optimizing the size of the individual pictures on that page is shown by commonly-assigned copending U.S. patent application Ser. No. 09/559,478, filed Apr. 27, 2000, entitled Method of Organizing Digital Images on a Page, by Richard A. Simon. Algorithms that find faces within a photograph and recognize objects within photographs are well known in the art, especially in consumer and professional photography applications and, more recently, in the Homeland Security area. Synthetic models of humans are shown using software packages such as Poser from e-frontier (www.e-frontier.com).

The workflow that a clinician follows can vary from one person to another, whether it is their standard practice, what their comforts and preferences are, or simply performing different functions within the same office. For this reason, the handling of the workflows in an application package of this nature needs to be flexible enough to handle them.

Canfield (www.canfieldsci.com) is a provider of camera systems and software to the plastic surgeons, dermatologists and other physicians performing cosmetic procedures. Their products range from cameras to camera systems to software specifically designed to take and analyze images for these specialties. They do not, however, assess and optimize the workflow of these clinicians nor are they particularly easy to use. They are relatively complicated cameras and do not address issues such as automated download and storage within the clinician's system, adding the images to a customized template, or any of the template features offered in the present invention. There is a direct analogy to consumer digital cameras, there is software to support the camera, but the bulk of what happens after the download is left to the user to handle. Canfield solutions are expensive and require specialized equipment in an effort to make images reproducible. The present invention requires no specialized equipment.

Color targets (for color consistency and color management) are well known in the art. Examples of companies that provide color targets for this purpose are MacBeth and Eastman Kodak Company. Photogrammetry (the ability to make measurements from photographs is also a well known science. The American Society of Photogrammetry and Remote Sensing, Manual of Photogrammetry, 5th edition, 2004 (Chris McGlone—Editor, Published by ASPRS) shows how this is done.

In U.S. Patent Application Publication No. 2002/0092534 A1 (Shamoun) a networked system for previewing potential effects of cosmetic surgery procedures. The present invention does not predict effect, but concentrates on the workflow aspects of the steps prior to the surgery without any prediction of outcome. While the present invention shows past results of other patients, no effect of the current patient is provided.

Similarly, U.S. Patent Application Publication Nos. 2002/0009214 A1 (Arima), 2002/0064302 A1 (Massengill), and 2005/0203495 A1 (Malak) refer to procedural methods of assisting with the surgery rather than improving the workflow of the steps before the surgery or showing pre-surgical information within the OR, without any predictive outcome methods as shown in these applications.

There are several offerings in the area of cosmetic and plastic reconstructive surgery that mention photographic images and systems within their offerings. These can be found on the Internet and examples include:
http://www.beautysurg.com/see/digital.html
http://www.plasticsurgeryimaging.com/
http://www.angelslab.com/
http://www.profectmedical.com/
http://www.niamtuimaging.com/
http://www.medicalmodeling.com/flashsite/splash.html

Each of these sites either provides a service to make a “before and after” photograph or attempts to predict the results of a surgery on an individual. There is nothing about the improvement of the workflow within a clinician's office nor mentions about improvements in the way the images are taken, edited, stored and/or shared for collaborative purposes. One such site, Profect Medical Systems, offers a photographic system, much like the Canfield offering, but does not assist in the management, manipulation or other aspects mentioned in the present invention. Niamtu Imaging Systems does offer image editing, but only for “before and after” images to attempt to make them look the same in terms of size and lighting. They only attempt to match the original image of the patient to one taken later and make no attempt to match this automatically, only to use standard image editing tools to do this (resize, adjust contrast, brightness, etc.).

The present invention creates a synthetic model to assist in taking the proper photos for many different purposes, not just “before and after” photos; these include: photos taken for use in surgery, teaching purposes, documentation, multiple procedures, training aids, and assistance is allowing non-clinical personnel to perform the photographic taking and editing in accordance to pre-determined needs.

Medical Modeling is a site that allows models to be created for use in medical applications. This site can be used as a source of the models used in the present invention in the same way Poser from e-frontier can be used. It does not, however, offer the workflow or the automation of that workflow seen in the present invention, nor does it provide for customized templates showing the photos that are to be taken for the purposes stated above.

### SUMMARY OF THE INVENTION

Briefly, according to one aspect of the present invention a system for plastic surgery comprises entering patient information into a database; computing a template for the patient based on the information; and inserting a synthetic model into the template.

The present invention allows for a camera agnostic methodology for clinicians to easily bring in photographs into an application specifically designed to optimize their workflow, minimize the manipulation of images, allow for data to be added to the images, advanced storage and retrieval capabilities, and allow for automated collaboration and usage in other applications.

It is a software application with optional storage hardware and utilizes customizable menus and preferences on data, searching and modifying templates for images. Instead of using a human model, a synthetic model is used. The model used is determined by the data for the particular patient. This data entry is part of the application.

The templates used are completely modifiable so that other or additional cell images can be added to, or substituted for, in a template. The software allows for alignment lines to be added to the cells. This allows for different poses to align themselves with each other along a common point.

### BRIEF DESCRIPTION OF THE DRAWINGS

FIG. 1a is a flowchart of typical workflow for plastic surgery clinicians.

FIG. 1b shows modification of the default workflow.

FIG. 2a is an example of a color/measurement target.

FIG. 2b illustrates how measurements can be taken with the target in the photo.

FIG. 3 shows a sample template and cells within a template.

FIG. 4 shows a sample sign on screen.

FIG. 5 shows a workflow and patient information screen.

FIG. 6 shows a sample synthetic models within a template.

FIG. 7 shows a “before and after” database.

FIGS. 8a and 8b show template modification screens.

FIG. 9 shows template/photo implementation screen.

FIG. 10 shows sample export screens.

### DETAILED DESCRIPTION OF THE INVENTION

The present invention has specifics in cosmetic and plastic surgery but can be used in other specialties where photographs are an integral part of the data collection process. This includes dermatology, dentistry, and others. It combines aspects of separate systems, allows for customization of the workflow within an office (even to different clinicians within an office), allows for manual tasks to be done automatically and combines image and patient data with multiple storage options and sharing capabilities. For the purpose of the present invention, workflow is defined as “A process description of how tasks are done, by whom, in what order and how quickly. Workflow can be used in the context of electronic systems or people, i.e. an electronic workflow system can help automate a physician's personal workflow.” The source of this definition is “Healthcare Informatics Online” and the URL is:

http://www.theebusinesssite.com/IT%20Terms/Health%20Terms.htm#sectW

In order to understand the present invention, one needs to understand the workflow in a typical cosmetic surgeon's (and others previously mentioned) office. In this scenario, the clinician can be the doctor, nurse, or a trained assistant. In fact, it may be a different person at specific steps.

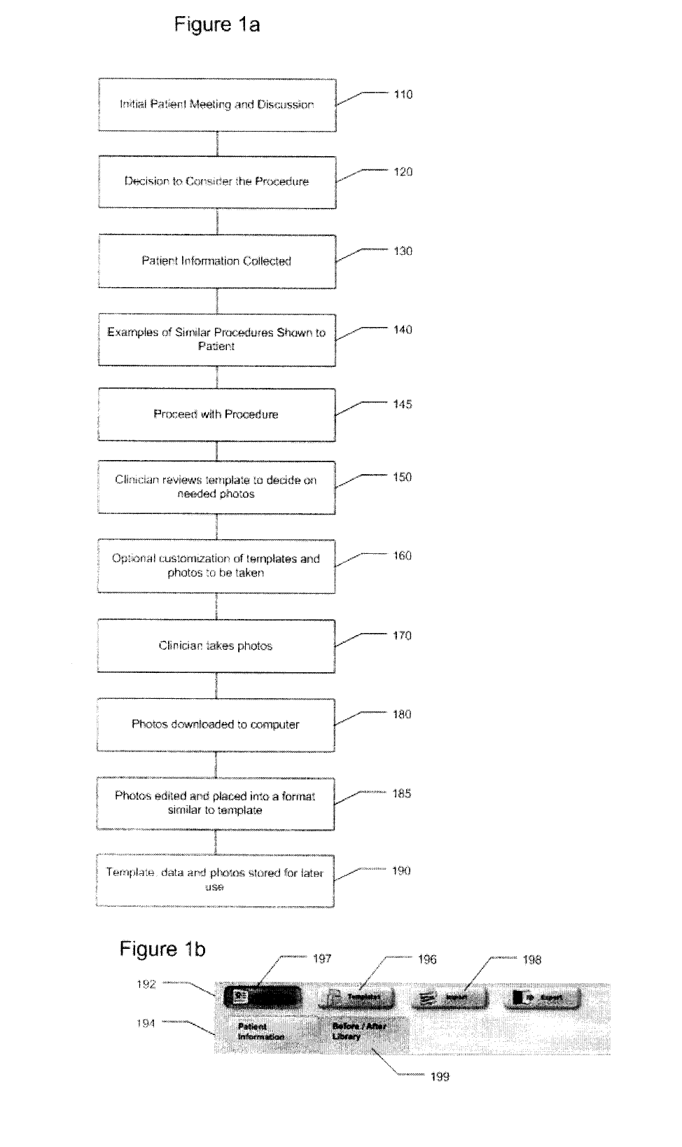

FIG. 1a is a flowchart that shows a typical example of pre-surgical workflow for a plastic surgeon. The first step is a meeting between the patient and the clinician(s) 110 to discuss the patient problem and talk about the procedural alternatives that are to be considered. Once it is decided (by both the patient and clinician) that there is something to be done for the patient 120, information about the patient that is pertinent to the case is collected 130. Samples of previous procedures, often called “before and after” photos are shown to the patient 140 so they can get an idea of the results that may be seen in their case. Once a decision of performing the procedure has been reached by the patient 145, the clinician then reviews the photographic standard templates to determine which photos are to be taken 150. Certain situation may occur when the clinician wishes to use a special template or photos that are different 160 than the ones suggested by the template. Photos are then taken 170 of the patient as suggested in the standard template. The software from the camera is typically used to download the images to the computer 180 or a standard interface such as TWAIN is used to bring them into a specific application. The photos are then edited 185 in a application program like PhotoShop (see www.adobe.com) or PaintShop Pro (see www.jasc.com). Typically, zooming, cropping, color adjustments and alignment from picture to picture within a template is done manually with this software. Additionally, the images are then combined into a single image and finally, the images are stored 190 for further use later on.

One can easily see how parts of this workflow would need to be modified for different clinicians and different patients. For example, one may choose to show the “before and after” images 140 before data on the patient is collected 130 or one may choose to take the photos 160 before selecting the template 150. Since there are a limited number of templates, a clinician may become familiar with the pictures that need to be taken and not need to reference the template. The present invention will allow for these changes in workflow by allowing a dynamic menuing structure that can be easily modified. This is shown in FIG. 1b. The general workflow buttons 192 can be positionally exchanged (in the setup part of the program) by “grabbing” and button 198 (for example) and moving this ahead of or behind another button 196 (for example). This will cause the buttons to exchange position (as can be done with sheets in Microsoft Excel) with each other. In this case, the result is a change in the logical next steps in the application program to match a different, but preferred workflow. In addition, the tabbed areas 194, which represent sub categories of a general workflow step 192, can be changed. In this case the tabbed area 199, currently assigned to a particular workflow category (patient information 197, in this case), can be reassigned to a different one such as templates 196 or import 198. The tabs in those categories would adjust their size, if needed. Similarly, the tabs can be moved in position within a workflow area by dragging them as the buttons were illustrated to be able to be moved previously.

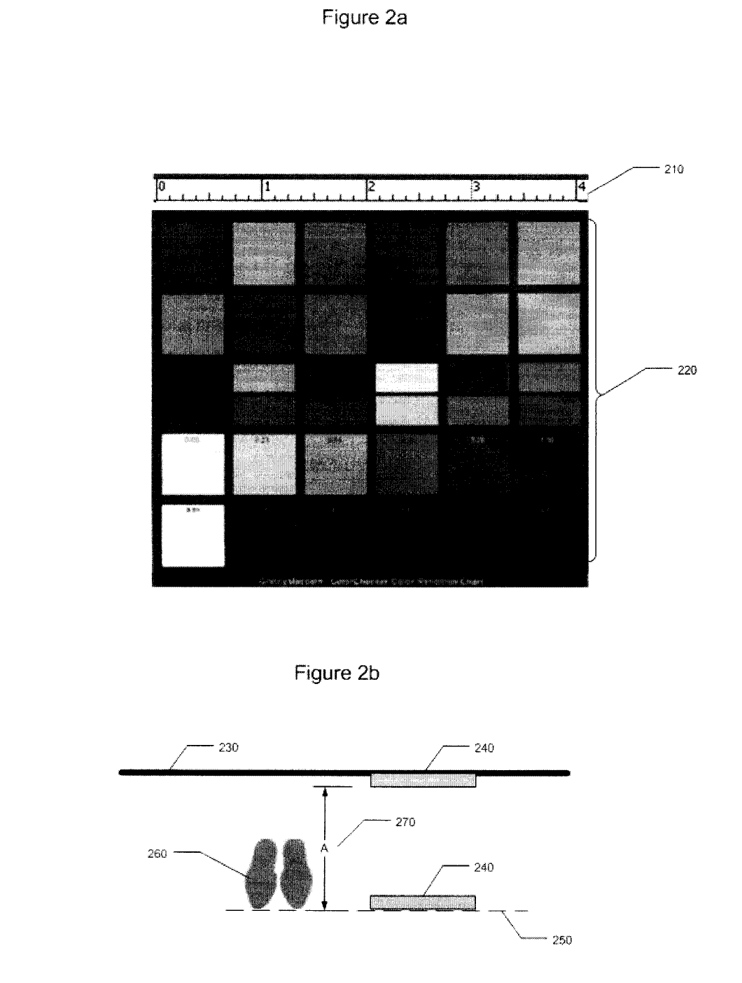

In dealing with photographs, especially those taken at different times and different conditions (lighting, backgrounds, different cameras, etc), it can be difficult to control the color of the images. Color differences can have significant meaning in dealing with medical images and a means to allow consistent color is important to the clinicians. In addition, there are times when it would be desirable to make measurements on the photographs (the science is known as Photogrammetry). FIG. 2a shows a target that can be used in a controlled environment to allow for both consistent color and allow accurate linear measurements to be taken. The target consists of two parts, a measurement area 210 containing a known scale and a color target area 220 containing color patches of known color values (such as a MacBeth color target or Pantone colors, both well known within the professional photography world). FIG. 2b illustrates how measurements can be obtained from a photograph taken with the target in the photo. The dimensions in the measurement area 210 are known. This target 240 is placed on a wall 230 or other background area that is fixed. The subject is then placed (via a set of shoeprints 260, for example) a specified distance 270 from the wall 230. Since this distance is known and the distance to patient and the distance to the target is known, linear scaling on the resulting photograph is possible. Alternatively, the target 240 can be placed on the same plane to the camera 250 and the subject 260. The known distances allow the scaling to be done as well. This also means that a movable target can be places on the same plane as a body part (hand, foot, finger, etc.) and the scaling is accomplished. By placing this target in a known distance from the camera and any part of the subject, we can assess the measurement information on the target relative to the subject and camera and determine linear measurements within the resulting photograph. By knowing the camera brand and model, color characteristics can be determined through standard profiles (known in the industry as ICC profiles) for that camera and by comparing the rendered color in the digital image with the standard patches on the target; the image can be corrected for a consistent color rendering. This can be carried through to printers and displays, if the ICC profiles and color management software. Please refer to the website of the International Color Consortium (ICC) (www.color.org) for more information on how this is done. By combining these targets and assigning known distances from the image to the target in specific templates. This can be done without assistance from the user (other than making sure the target is in the proper location and in the image when taken.)

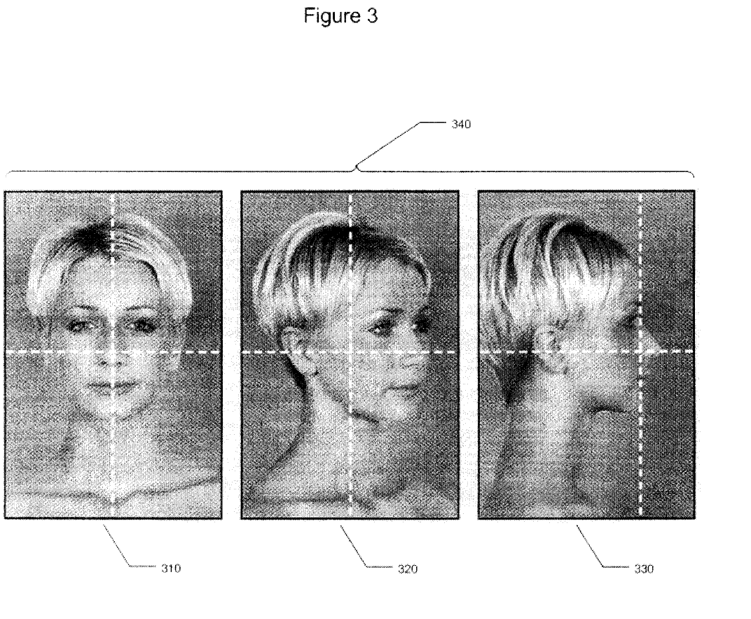

There is a need to define some terms for the present invention. A template is defined as a set of pictures designed to suggest the pictures to be taken for procedure on a particular part of the body. FIG. 3 is an example of a set of sample images suggested by the American Society of Plastic Surgeons and The Plastic Surgery Educational Foundation in their publication entitled: “Photographic Standards in Plastic Surgery.” This particular example is for the “Full Face” (there are 12 standard templates in the publication). The entire set of images 340 (there are three images) make up this particular template. The publication has as many as six images depending on the part of the body imaged. In fact, a clinician may decide to use more images, less images or different images in a particular procedure. If he chooses to save these for later use, this is a custom template for that clinician. The individual photos within a template 310, 320, 330 are known as “cells” for the template in the present invention. Alignment lines 340 are used to make sure that the cells are lined up properly with each other.

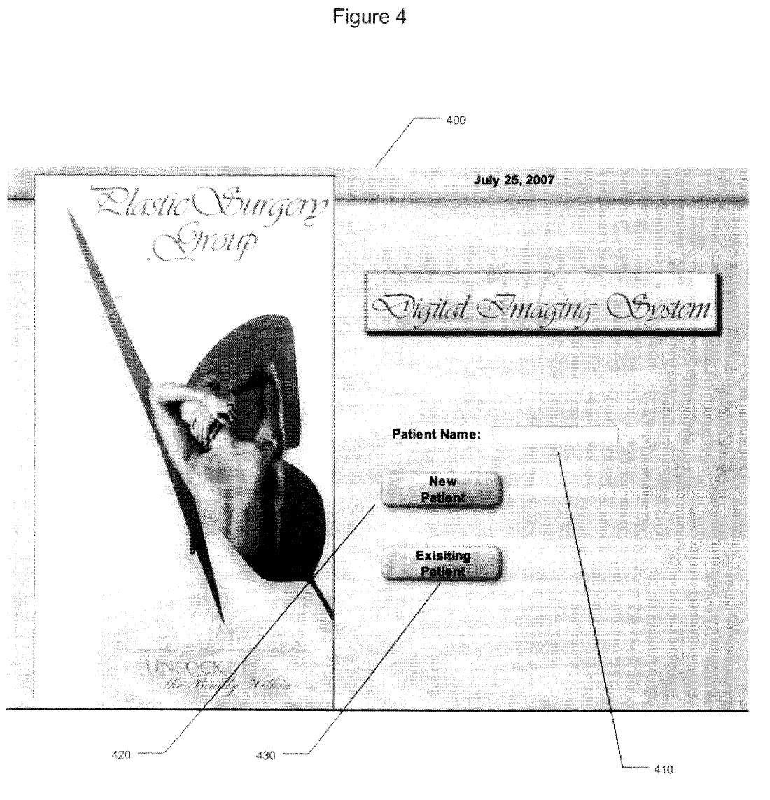

FIG. 4 represents an example of an integrated application specific for plastic surgery preparation. The way in which the workflow was shown in FIG. 1 is translated into the order and logic of the screens in the application.

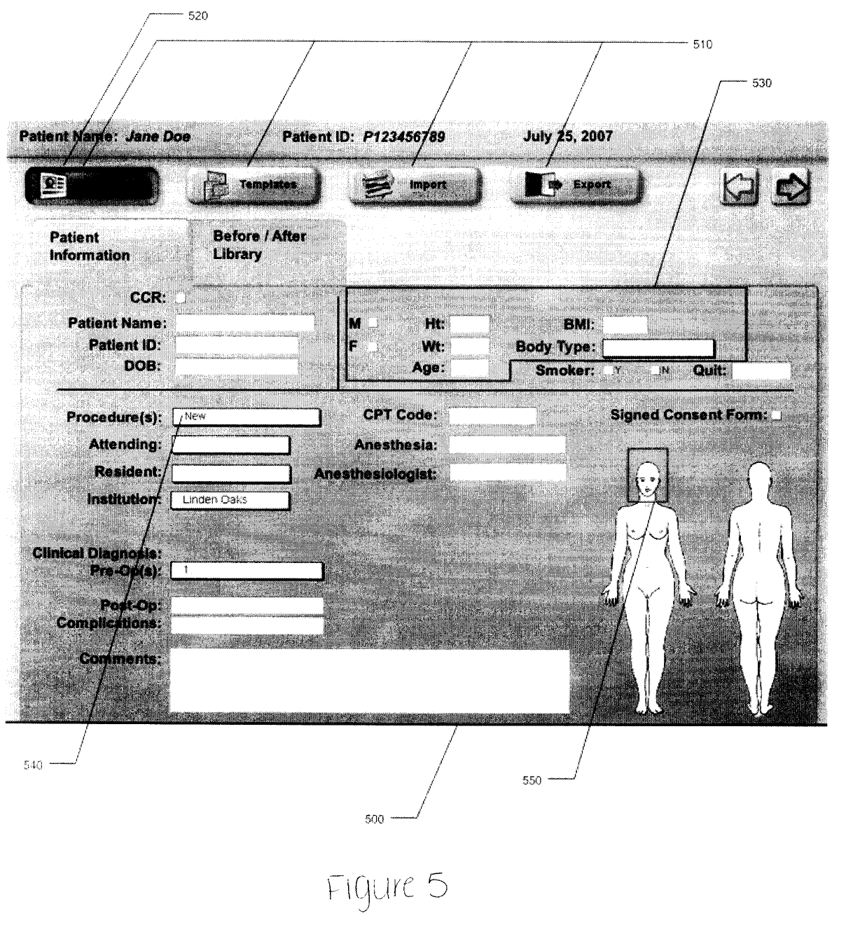

FIG. 4 represents an initial screen 400 for the example application. The only input here is the patient name 410 which is used to search the clinician's database if this is an existing patient 430. If this is the case, information about the patient (shown in FIG. 5) is automatically filled in. If this is a new patient 420, the data is filled in by the user. The selection of a new 420 or existing 430 patient leads to the data screen shown in FIG. 5.

FIG. 5 shows the patient data input form 500, but illustrates much more. The top level buttons 510 also represent the major components of the workflow as shown in FIG. 1. The tabs 530 (of FIG. 5) represent the rest of the workflow components. These are customizable in the setup area of the program where the top buttons 510 can be moved to match a different workflow. The tabs are also changeable and can be moved within a button or moved from button to button. Several pre-determined choices are also provided as standard sets in the setup utility. By allowing the menus and the tabbed areas to be changed, the workflow can be customized (functions modified, changed, added or deleted) to a particular clinician's preferences and allow different functions within the office (clerical, administrative, medical assistant, or trained professionals) to optimize this application to their particular needs.

All of the data fields shown in FIG. 5 are also customizable. Different clinicians and specialties have their own set of informational requirements. The data that is recorded here is able to be added to a patient record 520 (via an HL7 or CCR conversion utility, standard in the medical industry) and is also attached (as metadata to each photo) to the patient photos chosen to be used by the clinician. Each photo will have the same data from this page attached. The data (some or all of it) is also used in different parts of this application for other purposes.

One example is customization of the model that is used for overlaying patient photos. FIG. 3 shows a female model used for the image template, but, even though recommended by the aforementioned organizations, it can become difficult to match photos of patients of different sex, weights, heights, body types and body mass indexes. This information is all part of the standard information gathered by plastic surgeons in preparation for procedures, as well as the type of procedure and the place on the body where the procedure is to be done. This personal data 530, the procedure to be considered 540 and the body location as illustrated on the homunculus 550 can be used to create a synthetic model much more closely matching that of the patient. The body location element 550 is also useful for predetermining the templates that are in consideration for the procedure on the patient.

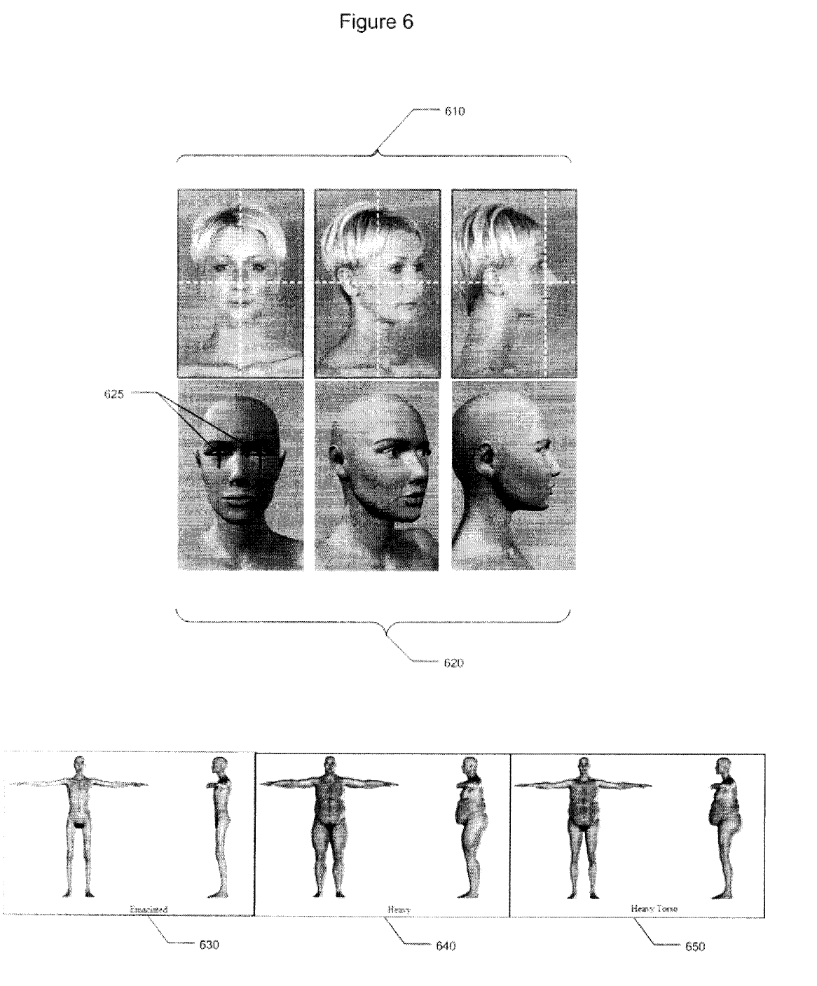

An example of how a synthetic model is advantaged over a human model is illustrated in the case of a very large male patient about to undergo a series of procedures to sculpt his body via liposuction and body sculpting surgeries. It is very cumbersome to try and match the patient images (different height, weight, sex, body type, etc.) to the slender female in the template, as well as set up the alignment lines. A synthetic model of the approximate weight, height and sex of the patient with the same body type would make this very simple. Software such as Poser from e-frontier allows these synthetic models to be generated. This can be done on the fly with the data provided or a set of models can be pre-rendered. Examples of these poser models are abundant on the Internet. FIG. 6 shows an example of a synthetic model used in lieu of a human one. A template using a human model 610 can be replaced by a synthetic model 620. Alignment locations 625 are shown on the synthetic image. The application of the current invention allows the user to identify these points on the patient image. With this information, the patient images can be sized and matched to the template cell automatically. It is envisioned that these alignment locations will be on each of the template cells.

Note that the synthetic model in 620 is in its basest form and features such as hair and clothing can easily be added in software applications like the aforementioned Poser software. In this example, patient information like gender, age, weight and body mass index can be used to find a pre-rendered model that most closely approximates the patient. Additionally, in another embodiment, the same characteristics can be used to generate a model directly from the software that generates the model and completely customized to the particular patient. There are other advantages to using a synthetic model over a human one, including the time and cost to employ a human model and licensing and royalty fees that can incur. In addition, the model is separable from the background and is a distinct object that can be scaled, moved or posed within each cell of the template. If desired, the model can even be made to look like the patient by mapping the patient's photograph onto the model (well-know in the art of photography and 3D-modeling). Software like Poser allows modification of almost every part of the body. Examples are a male emaciated body 630 and male with a heavy body 640 or a body with a heavy torso and normal lower body 650. These synthetic models can be exported to 3D packages that would allow further functionality to be implemented. It is also possible with current know technology to be able to automatically map photos onto these models. Technology examples include, but are not limited to, face finding so that we can automatically place a patient image into a template cell of a face and object recognition technology that can identify a body part (torso, hand, foot, finger, etc) and automatically place patient photos into these templates. In addition, Poser provides for the models to be edited so that information for a particular patient can be used to provide a reasonable model for each individual.

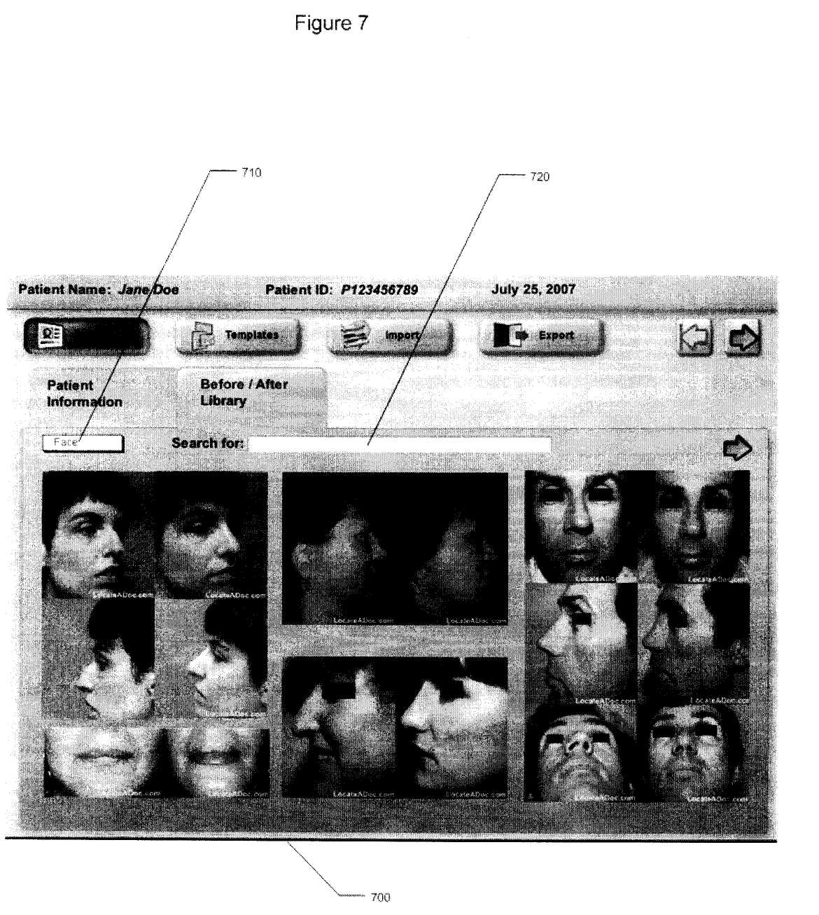

FIG. 7 illustrates how the present invention uses information from the data sheet shown in FIG. 5 to assist the clinician's effort in improving the workflow of finding samples of previous work to show a new patient what can be expected. These “before and after” photos 700 are currently kept in a physical photo album or digitally on a computer. There may even be some information about these in a related database. The present invention differs from this due to the integrated nature of this function and the ability to interactively label and find specific images of interest. When the procedure 540 (in FIG. 5) is entered, it triggers the body field 710 to the part of the body of interest and limits the before and after photos to those of potential interest to the patient. In addition, the clinician can use the search field 720 to further limit the choices. Any information collected on the patient information screen 500 can be used as a search criterion in the search field 720. An example of this is the Google Desktop, which will search your computer using words you enter. The present invention integrates this functionality and limits it to the data collected.

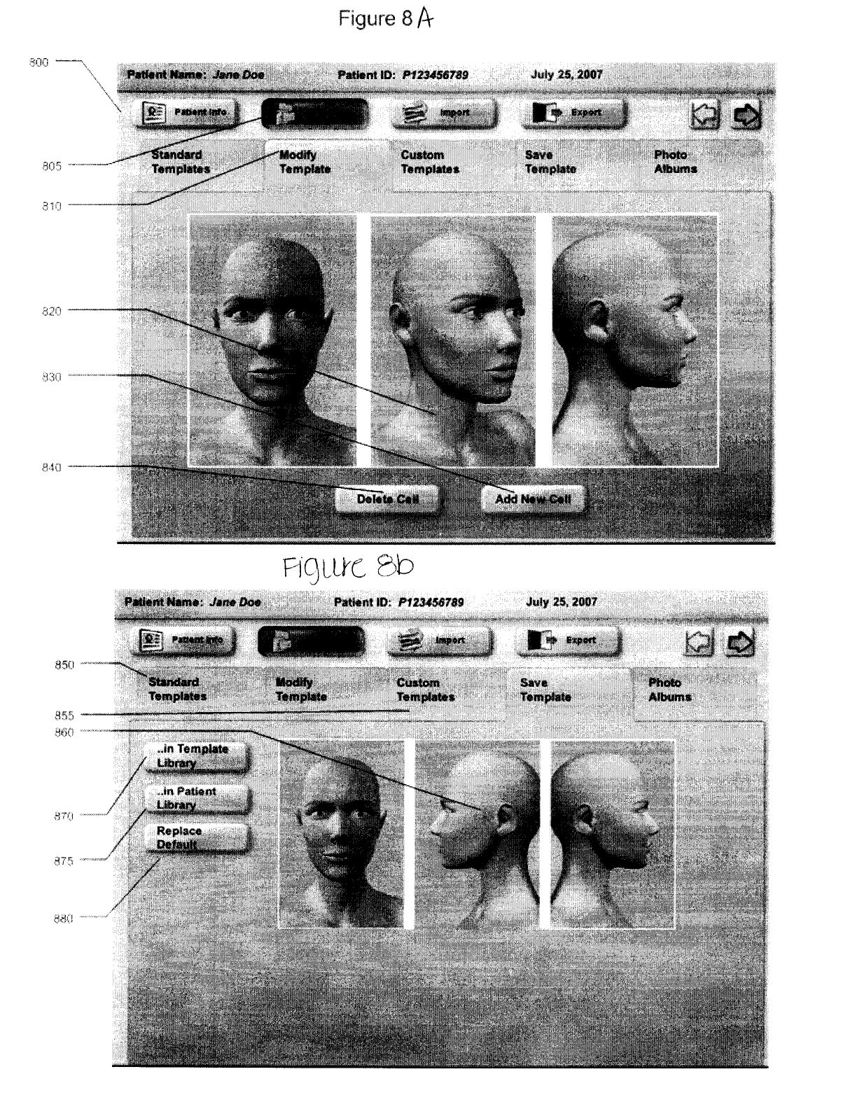

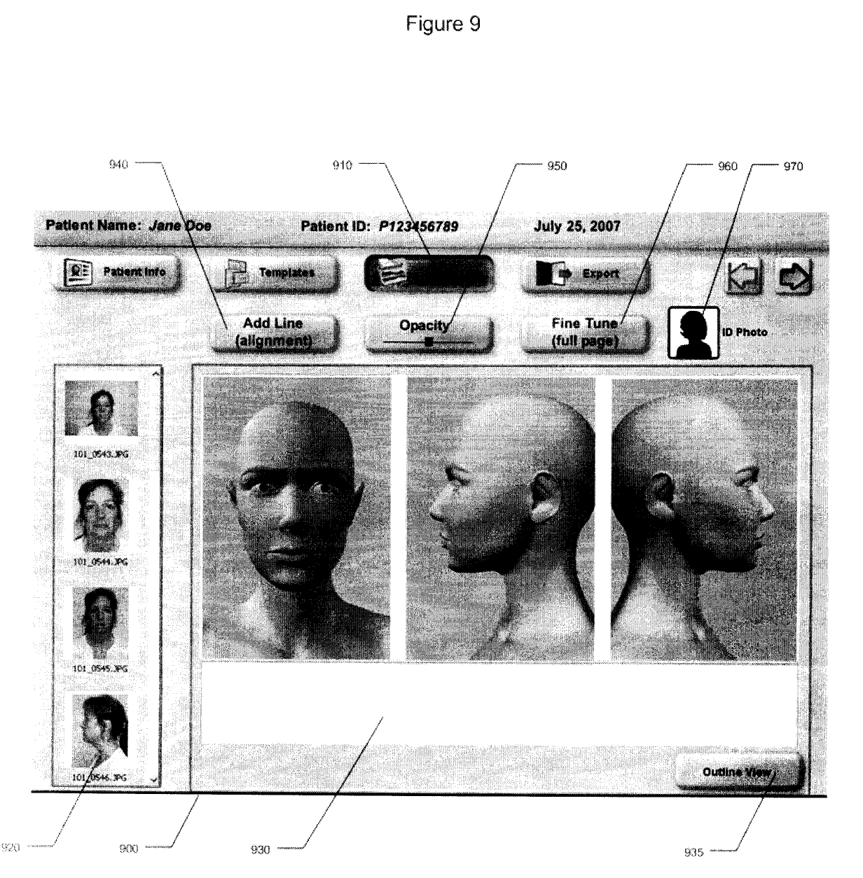

FIGS. 8a and 8b illustrates another workflow improvement over current methodologies. In this case, the clinician is allowed to modify a template for a particular procedure and replace and/or remove any of the cells within a template.

Once a template has been chosen, the present invention allows for a modification option 800. Within the templates main area 805, there is a tab or selection for modifying the template chosen 810. A method is shown on how to add 830 or delete 840 a cell from the template. If a different number of cells (from the original template) are used, the template will automatically resize and realign the cells to optimize placement on the page. This is done using a means shown in commonly-assigned copending U.S. patent application Ser. No. 09/559,478, filed Apr. 27, 2000, entitled Method of Organizing Digital Images on a Page, by Richard A. Simon. Taking this a step further, it can be seen how a photo can be taken of a patient and used in several different templates by simply cropping and zooming the photo appropriately. A photo can be taken of the entire body and be used for the facial templates, mid, and lower body templates by zooming in and cropping the image. With digital cameras routinely having the ability to take 5-20 Mega pixel photos, the resolution is more than enough to make this possible.

In this example of modifying a template, it is desired to remove the middle cell 820 which is a ¾ profile and replace it with a left profile 860. This cell is chosen from a library of poses and templates 855 that were pre-rendered for this purpose. If desired, a 3D model can be used and made to move into any position and pose desired. While this may provide more functionality, the time taken to do this could be a productivity problem. In the preferred embodiment, this is an option, but not the standard means of providing new cells for modification. Once the new template has been created, it can be saved in the library 870 for later use, saved in a patient library for use with a particular patient only 875, or can replace the default template 880 within the standard template area 850.

While this functionality works with a human model and taking photos of the model with different pose changes, it is much more cost effective using the synthetic model. Not only will the model not be required for shots that were not taken (cost and time advantages), but specific model modifications are possible with the synthetic version (hair, facial feature modifications, etc). Specific features of a patient can automatically be detected and applied to the model directly that would enhance the ease of photo placement. Examples are facial shape, eye parameters, lip and nose size and shape, and many others. Advancements in face-finding algorithms and object recognition make this a reasonable feature, as long as the workflow is not interrupted or extended. This capability enables any body type, and any pose of any part of the body (as well as the entire body). This flexibility greatly enhances the workflow and customization of the processes involved in this type of application. Since software like Poser allows for animations to occur as well, a model can be animated to determine the pose in any particular patient case.

The workflow now moves to the Import functionality 910. Images are selected using standard OS methods (explorer, “open”, or camera and scan directly into the application using TWAIN or similar methods) and brought together with the chosen template onto a placement screen 900. The current art has the clinician using a different, general purpose application to create the template images (PhotoShop, PaintShop Pro). This is a painstaking process that requires skill in the use of these applications and the applications are not set up to perform the specific functions as the current invention. Observations on clinical workflow have seen as much as 30 minutes to perform this task when it can be done in less than a minute with the current invention. The appropriate photo is chosen from the thumbnails 920 and placed into the appropriate cell in the template where the image is aligned and sized to the model in that cell. This function can be automated where the proper image for the cell is automatically selected (via image analysis looking for a particular pose and features), placed within the proper cell, and sized properly (using face detection and facial feature finding on both the cell model and the patient photo) and placed properly within the cell. All of the technologies mentioned here are well known in the art of professional photography. A comment area for clinician notes 930 is also provided.

Several features are shown to aid in the placement of these images into the cells by the clinician. An outline view 935 allows only an outline of the synthetic model to be seen (as opposed to the fully rendered model). It has been observed that some clinicians find on outline easier than an overlay on a fully rendered model. Another feature is alignment from photo to photo within a template. This is recommended and shown on the physical brochure showing the templates. The alignment feature 940 allows lines (across the cells within the template) to be added that shows alignment to a common feature or features (nose, ears, hips, etc.). The user can add as many of these alignment lines as desired in the X or Y dimension (horizontal and vertical). The model within the cells can also be moved (X and Y) within the cell, as well as the lines themselves, to allow for different type of alignments.

Opacity is the degree of visibility of the template and the photo so that they can be overlaid and matched. The opacity feature 950 provides an interactive means to control how opaque the photo or the template is when matched. Fine tuning of the image to the template may be desired, especially around body extremities. The fine tuning feature 960 allow any of the cells to be seen full screen and zoomed to a finer level.

An additional feature of the current invention is the ID photo embedded into the application. The concept of an ID photo associated with a patient record is not new. This feature simply allows for the integration of that at the same time photos are used for another purpose (placing them into templates). This is another workflow improvement. There is no longer the need to do this as an independent function using another piece of software. The ID photo can be of significant importance in reducing clinical errors. One of the key outputs of the current invention is for use in the operating room (OR) as a key to the surgeon as to what needs to be done. Many of the templates do not have the patient's face in them. With this, the photo is always available to the surgeon as another patient check. In the current invention, a photo of the patient's face is dragged into the ID photo icon 970 and this is kept s part of the template and file.

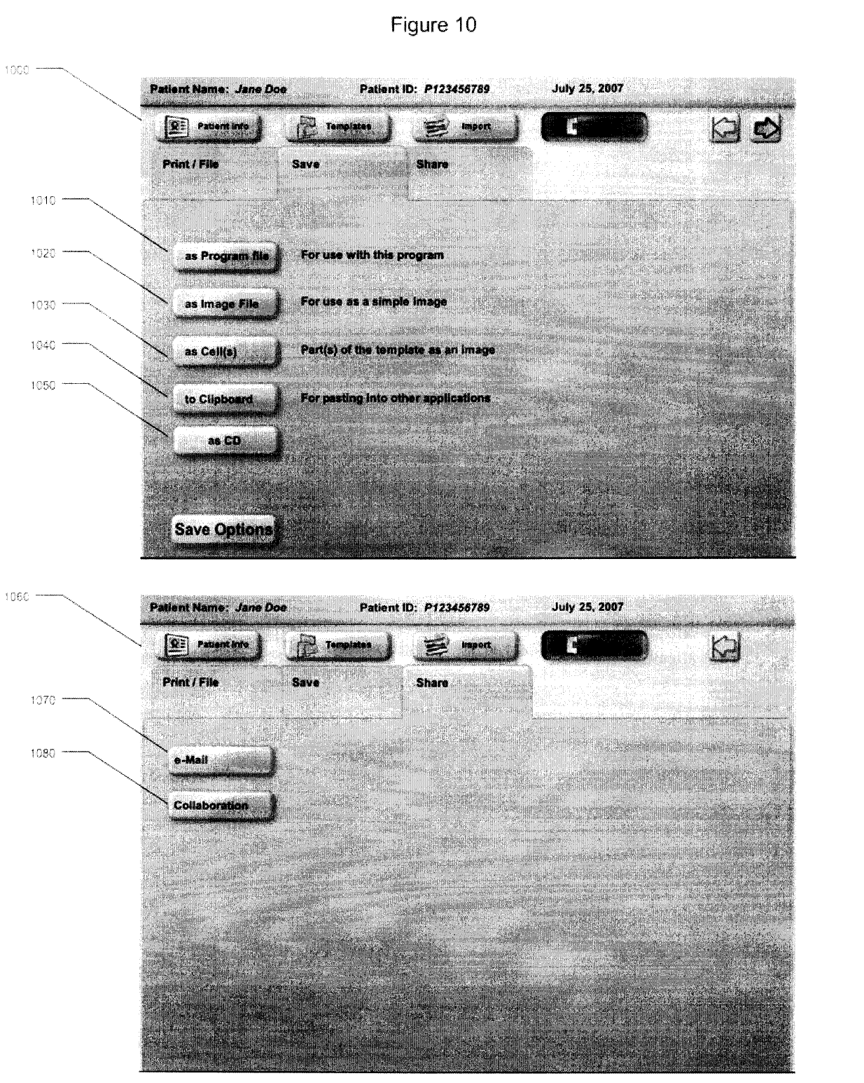

There are significant workflow gains to be realized when the effort to construct the templates is completed and the clinician proceeds to next steps. There are several ways in which these finalized templates are used and shared. FIG. 10 shows how the export part of the workflow for saving 1000 and for sharing 1060 options. The save page 1000 shows the different save formats that are made available and that multiple save options are made available concurrently.

The standard save for use within the application 1010 allows for the clinician to stop the work short of completion and continue at a later time. Saving the work as an image file 1020 allows for the image to be used in other applications that accept standard image files (JPEG, BMP, etc.). The option to save the individual image cells 1030 allows for a single, or selected multiple images, to be saved in a standard image format. A “clipboard” save is a standard Microsoft Windows feature for quick pasting into other applications. This is shown as the clipboard button 1040. The entire file (images, metadata, and links to the files) can be saved to a CD 1050 for use in an off-site area, such as an OR. commonly-assigned copending U.S. patent application Ser. No. 11/555,313, filed Nov. 1, 2006, entitled Automated Custom Report Generation System for Medical Information, by Squilla et al. shows an example of such an offsite application where this information can be incorporated. By having a CD (or other portable storage, like a jump drive), the clinician is able to bring the data without the dependency on a network or the Internet. This can be especially useful in secure settings or where computer access is limited. The clinician can also provide their computer, if desired. Each, all, or any combination of these “save” options is selectable. When a choice 1010, 1020, 1030, 1040 or 1050 is made, the selection stays highlighted until it is selected again, when that choice is turned off. The same is true for the “share” options 1060. In this case, the options allow for an e-mail 1070, collaboration 1080 or other sharing capabilities (video conferencing, net meetings, etc.). Linking in e-mails is a standard function seen in many Windows applications and technologies such as JPEG and Zoomify allow for high-resolution, high-speed communications of images. As in the “save” menu, these can also be selected at the same time.

The invention has been described in detail with particular reference to certain preferred embodiments thereof, but it will be understood that variations and modifications can be effected within the scope of the invention.

### Parts List

110 initial meeting
120 consider procedure
130 patient information collected
140 examples of procedures
145 decision to have procedure
150 review of standard templates
160 customize template
170 photos taken
180 downloading of images
185 photos edited
190 storage of template
192 buttons simulating clinician workflow
194 tabs simulating steps within workflow components
196 templates button
197 workflow modification by changing button position
198 workflow modification by changing button position
199 tab capable of being moved to different workflow step
210 measurement target
220 color target
230 wall
240 target
250 camera
260 indicator for patient placement
270 distance from patient to target on wall
310 cells within a template
320 cells within a template
330 cells within a template
340 template
400 initial screen
410 name field
420 indicator for new patient
430 indicator for existing patient
500 patient information screen
510 buttons for general workflow
520 patient information button
530 patient personal information
540 procedure field
550 body area indicator
610 template using human model
620 template using synthetic model
625 alignment locations
630 emaciated synthetic model
640 heavy synthetic model
650 heavy torso synthetic model
700 before and after examples screen
710 body part indicator/selector
720 search field
800 template modification screen
805 template workflow button
810 modify template tab
820 cell to be modified
830 add cell option
840 delete cell option
850 standard template tab
855 custom template tab
860 modified cell
870 save in template library button
875 save in patient library button
880 replace default button
900 screen for placing images into template
910 import workflow button
920 selected patient images
930 comment area
935 option to show outline view of template
940 button to add lines for cell alignment
950 opacity modification
960 show cell in full page mode
970 means for placement of ID photo
1000 export workflow screen
1010 option for saving as program file
1020 option for saving as image file
1030 option for saving part of template
1040 option for saving to clipboard
1050 option for saving to CD for use elsewhere
1060 export share screen
1070 export to e-mail
1080 collaboration with another clinician

1. A system for plastic surgeons, dermatologists and other physicians performing cosmetic procedures comprising:
entering patient information into a database;
computing a template for the patient based on the information; and
inserting a synthetic model into the template.

2. The system of claim 1 wherein the patient information is selected from a group comprising biometric data, patient personal information, procedure type.

3. The system of claim 2 wherein the template is resized based on the patient biometric data.

4. The system of claim 1 wherein the synthetic model is created from the patient information.

5. The system of claim 2 wherein the template is comprised of poses based on the procedure type.

6. The system of claim 1 wherein the template is modified by a clinician's preference.

7. The system of claim 1 comprising:
using photographs of the patient as a template for subsequent procedures.

8. The system of claim 1 comprising:
taking a second photograph of the patient; and
aligning at a least one feature in the first and second photographs.

9. A system of claim 1 comprising:
customizing the workflow via a dynamically changeable menuing system.

10. A system of claim 1 comprising:
integrating an identification photo into the patient file and for later use.

11. A system of claim 1 comprising:
automatically placing and sizing the images within the template.

12. A system of claim 1 comprising:
integrating a color and measurement target for photographic images.

13. A system of claim 1 comprising:
providing multiple simultaneous save options and sharing options.

14. A system of claim 1 comprising:
providing a patient image capture process step guide for image protocols to assist in following surgical protocols.

15. A system of claim 1 comprising:
further comprising program arrangements for providing the patient images in active animation.

16. A system of claim 1 comprising:
providing a utility to automatically view the template in an electronic health record system.
